(19) United States
(12) Patent Application Publication
(10) Pub. No.: US 2025/0101277 A1
(43) Pub. Date: Mar. 27, 2025

(54) WATER-BASED TPO ADHESIVE WITH ONE-SIDE APPLICATION

(71) Applicant: Franklin International, Inc., Columbus, OH (US)

(72) Inventors: John William Duffy, Hatboro, PA (US); Mark A. Vrana, Lancaster, OH (US); Tanzin Fatima, Philadelphia, PA (US)

(73) Assignee: Franklin International, Inc., Columbus, OH (US)

(21) Appl. No.: 18/370,962

(22) Filed: Sep. 21, 2023

(51) Int. Cl. C09J 133/08; C09J 11/04; C09J 11/06; C09J 11/08; C09J 111/00; C09J 129/04

(52) U.S. Cl. CPC C09J 133/08; C09J 11/04; C09J 11/06; C09J 11/08; C09J 111/00; C09J 129/04; C09J 2301/312; C09J 2301/408; C09J 2301/50

(57) ABSTRACT

Commercially available waterbased adhesives can be used to adequately secure unmodified TPO roofing membrane to a roof substrate only by using a two-sided (contact bond) application. Alternatively, commercially available waterbased adhesives may be used a single-sided application using TPO membrane that is modified at manufacture with an additional backing (“fleece back”). Disclosed herein is a water-based adhesive formulation that will bond unmodified TPO membrane to the roof with a one-sided application, saving money and increasing productivity. The disclosed adhesive is applicable by high pressure canister application, facilitating the efficiency of its use.

### BACKGROUND

The present invention relates to adhesives for polymer membranes and more particularly, to water-based, low VOC, adhesives for thermoplastic polyolefin (TPO) roofing membranes capable of sufficiently adhering the membrane to an underlayment with a single-surface application. The invention also relates to methods of using the described adhesive to secure TPO membrane roofing to a substrate.

Thermoplastic polyolefin (TPO) membranes have gained widespread use in the roofing industry. TPO membrane roofing products are offered by Carlisle SynTec of Carlisle, PA, Firestone Building Products of Nashville, TN, GAF Materials Corporation of Parsippany, NJ, Johns-Manville of Denver, CO and others. TPO membranes are made of thermoplastic polyolefin elastomers, which are part of a family of rubberlike materials that are designed for strength, weatherability, fire and chemical resistance and durability. In the case of roofing applications, TPO offers resistance to ozone and ultra-violet light, is highly resistant to tears, impacts and punctures and exhibits good flexibility to allow for building movement and has been found to be excellent for low-slope conventional roofing applications. These materials are designed to provide the durability of rubber and offer excellent resistance to algae, are environmentally friendly and safe to install. In addition, TPO membranes can be reprocessed and recycled like other thermoplastic materials.

TPO membranes for roofing applications may be a single layer or may be composed of multiple layers and may have fleece attached to the bonding side, especially when used with water-based adhesives or hot asphalt adhesives. TPO membranes are installed either fully adhered, mechanically attached or ballasted. Fully adhered means that the roofing membrane is “glued” to a substrate using a special adhesive. Although a fully adhered installation is the preferred (quickest, most economical and best wind resistance performance), because of the polymer construction or nature of the membrane, a special adhesive must be used to adequately adhere the membrane and the substrate.

The special adhesives which were initially developed for applications of bonding a TPO membrane to a substrate and which adhere well to the TPO membrane are not environmentally friendly. Historically, these special adhesives which bond well to the TPO membrane contain high levels of volatile organic compounds (VOC's) to dissolve the polymers and resins used to bond these membranes. These VOC's are primarily petroleum-derived solvents or compounds that have a high vapor pressure and low water solubility. The VOC's are released into the air upon evaporation and are photochemically reactive, thus adding to atmospheric ozone, smog and pollution. Solvents that are typically used in traditional roofing contact adhesive include, but are not limited to: toluene, xylene, heptane, hexane, ethyl acetate and methyl ethyl ketone.

In recent years, there has been an increased effort by local, state and federal agencies to limit the amount of VOC's that are released into the atmosphere by commercial/industrial processes, including commercial roofing. As a result, restrictions on the total VOC content for roofing adhesives have become more common. This has driven efforts to develop low VOC, water based, adhesives capable of providing adequate adhesion between the TPO membrane and a roof substrate.

Although adhesives containing zero or very low levels of VOC's are available, they typically do not bond very well to TPO roofing membranes due to the low polarity and low surface energy of these membranes. For example, a representative commercial adhesive promoted for use with TPO membrane roofing is Carlisle Aqua Base 120 Bonding Adhesive, sold by Carlisle SynTec of Carlisle, PA. The instructions provided with the product state that it may be used as a one-sided, or wet lay-in, adhesive only for TPO membrane products provide with a fleece backing. For unmodified TPO membranes (membranes without fleece backing), a two sided application method is required to obtain adequate adhesion of the membrane. In addition to the increased time and material required by the two-sided application, both sides must be allowed to dry before the membrane is affixed to the substrate. Extended drying times can be expected in cool, overcast, humid, shaded or late-day application conditions.

Due to the chemical composition of the TPO material, a low or no VOC containing water-based adhesive which can adequately adhere to the TPO material with a one-sided (wet lay-in) application method has not to date been developed. Accordingly, there is a need to provide a water-based adhesive for TPO roofing membranes that can be applied with a one sided, wet lay-in method and that can meet the reduced VOC regulatory requirements without sacrificing efficiency or bond quality.

### SUMMARY

The adhesive technology disclosed herein provides a water-based TPO adhesive capable of one-sided, wet lay-in, application, and with outstanding adhesion. The adhesive formula is free of VOCs. Methods of using the TPO adhesive for TPO roof membrane installation are also disclosed.

### DETAILED DESCRIPTION

The following disclosure is presented to provide an illustration of the general principles of the present invention and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign particular meaning. Further, it should be noted that, as recited in the specification and in the claims appended hereto, the singular forms “a,” “an,” and “the” include the plural referents unless otherwise stated. Additionally, the terms “comprises” and “comprising” when used herein specify that certain features are present in that embodiment but should not be interpreted to preclude the presence or addition of additional features, components, operations, and/or groups thereof.

The following disclosure is intended to be read in connection with the accompanying drawings, which are to be considered part of the entire written description of the invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise, and includes terms such as “directly” coupled, secured, etc. The term “operatively coupled” is such an attachment, coupling, or connection that allows the pertinent structures to operate as intended by virtue of that relationship.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

“Substantially free” is defined herein as less than 0.01 wt. %. “Substantially free” also includes 0.00 wt. %. The term “free of” means 0.000 wt. %. As used herein, “about” is intended to correspond to ±5% of the stated value.

As used herein, a “filled” adhesive refers to an adhesive formulation that includes a filler material including, but not limited to, glass, silica, limestone, phyllosilicates, clay or nano-particles. Adhesives which lack filler material are referred to herein as “unfilled” adhesives.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.01 weight percent, based on the total weight of the composition in which such components are employed. All amounts are weight percents, unless otherwise specified. All weight percents are based on the total composition, that is a total of 100%.

All references, including publications, patent applications, and patents, cited herein are hereby incorporated by reference to the same extent as if each reference were individually and specifically indicated to be incorporated by reference and were set forth in its entirety herein.

The present invention relates generally to water-based adhesive compositions for securing building materials, such as membrane roofing, to a structure. The adhesive composition is especially useful for adhering adhesion-resistant materials, such as TPO, with a strength meeting or exceeding industry standards. Unlike commercially available adhesives, the adhesive composition may be used with unmodified TPO using a one-sided, wet lay-in installation method. The water-based adhesive composition is substantially free from VOCs. The water-based adhesive composition comprises the following ingredients.

A first emulsion polymer. In one example, the first emulsion polyer is an acrylic copolymer. A preferred emulsion polymer is FRANKLIN COVINAX™ RFP-00, produced by Franklin International of Columbus, OH. Another preferred emulsion polymer is FRANKLIN COVINAX™ 1000. A third is FRANLIN COVINAX RFP-VVEH. Preferably the emulsion polymer comprises from 10 to 80 percent by weight of the adhesive composition, more preferably from 30 to 50 percent.

A second emulsion polymer. Preferred second emulsion polymers are POLYCHLOROPRENE SD78, which is an anionic polychloropene copolymer rubber produced by Showa Denko K.K. of Tokyo, Japan, VINNAPAS EP7000, which is a poly(vinyl alcohol) stabilized vinyl acetate-ethylene (VAE) copolymer dispersion produced by Wacker Chemie AG of Munich, or an additional emulsion polymer. Preferably the second emulsion polymer comprises from 10 to 55 percent by weight of the adhesive composition, more preferably from 20 to 30 percent.

A rosin ester dispersion. A preferred rosin ester dispersion is KRATON AQUATAC™ 2685, produced by the Kraton Corporation of Houston, TX. Preferably the rosin ester dispersion comprises from 10 to 30 percent by weight of the adhesive composition, more preferably from 13 to 25 percent. In a preferred example, the rosin ester dispersion has a viscosity ranging from 150-1000 cps and is substantially free of alkyl phenols.

A chlorinated maleic anhydride modified polyolefin dispersion. A preferred chlorinated maleic anhydride modified polyolefin dispersion is API ADVABOND®7251, produced by Advanced Polymer, Inc. of Carlstadt, NJ. Preferably the chlorinated maleic anhydride modified polyolefin dispersion comprises from 1 to 10 percent of the adhesive composition, more preferably from 3 to 7 percent by weight.

An isobutyrate-based coalescent/plasticizer. A preferred isobutyrate-based coalescent is TRIMETHYL-1,3-PENTANEDIOL ISOBUTYRATE. A preferred TRIMETHYL-1,3-PENTANEDIOL ISOBUTYRATE is TEXANOL™, produced by Eastman Chemical Company of Kingsport, TN. Preferably, the isobutyrate-based coalescent comprises from 0.2 to 5 percent by weight of the adhesive composition, more preferably from 0.5 to 3 percent by weight.

Hydroxyethylcellulose. A preferred Hydroxyethylcellulose is ASHLAND NATROSOL™ 250, produced by Ashland Inc. of Wilmington, DE. Preferably, the hydroxyethylcellulose comprises from 0.1 to 2 percent by weight of the adhesive composition, more preferably from 0.5 to 1.0 percent.

An aqueous ammonia solution comprised of 28 percent by weight of ammonia. Preferably, the aqueous ammonia solution comprises from 0.01 to 0.5 percent by weight of the adhesive composition.

An epoxy-functionalized silane or silane oligomer. A preferred epoxy-functionalized silane oligomer is Evonik Dynasylan® VPS 4721, produced by Evonik Industries AG. A preferred epoxy-functionalized silane is KBE-402 produced by Shin-Etsu Silicones. Preferably the epoxy-functionalized silane or silane oligomer comprises from 0.1 to 2.5 percent by weight of the adhesive composition, more preferably from 0.5 to 1.5 percent. Preferably, wherein the epoxy-functionalized silane oligomer is of high molecular weight with viscosity at 20 C of 700-1200 centistokes.

The compositions disclosed herein exhibit excellent ability to secure roofing membranes, including TPO, to a roof deck. The compositions need only be applied to one of two surfaces being bonded, result in an adhesive strength meeting or exceeding the industry standard of a peel strength of 5 piw (pounds per inch of bond width), even at a temperature of 120 F-140 F, and the surfaces can be joined while the adhesive composition is still wet (wet-set).

In a first example composition including a poly(vinyl alcohol) stabilized vinyl acetate-ethylene (VAE) copolymer dispersion as the second emulsion polymer and an epoxy-functionalized silane, five months after the joining of surfaces, a TPO to plywood peel strength of 28 piw was measured at 72 degrees Fahrenheit, and a TPO to plywood peel strength of 6.3 piw was measured at 140 degrees Fahrenheit. In a second example composition including an anionic polychloroprene copolymer rubber as the second emulsion polymer and an epoxy-functionalized silane oligomer, five months after the joining of surfaces, a TPO to plywood peel strength of 20 piw was measured at 72 degrees Fahrenheit, a TPO to aluminum peel strength of 18 piw was measured 72 degrees Fahrenheit, and a TPO to plywood peel strength of 8.1 was measured at 140 degrees Fahrenheit. In a third example composition including a poly(vinyl alcohol) stabilized vinyl acetate-ethylene (VAE) copolymer dispersion as the second emulsion polymer and an epoxy-functionalized silane oligomer, five months after the joining of surfaces, a TPO to plywood peel strength of 9 piw was measured at 72 degrees Fahrenheit, a TPO to aluminum peel strength of 12 piw was measured at 72 degrees Fahrenheit, and a TPO to plywood peel strength of 6.5 was measured at 140 degrees Fahrenheit.

### Methods of Use

A significant advantage of the adhesive composition according to embodiments of the present invention is that they enable methods of application wherein the water-based adhesive need only be applied to one of two surfaces to be joined together, and the surfaces may be joined while the adhesive composition is still wet. In prior art methods, particularly for building materials such as unmodified TPO, that are difficult to adhere, an adhesive must be applied to both of two surfaces to be joined, and the adhesive must be allowed to dry before the two surfaces are joined together. Alternatively, the commercially available water based adhesives may only be effectively used on TPO that has been modified, such as with a fleece backing.

For example, in an embodiment of the disclosed invention, a method for installing membrane roofing to a roof deck, comprises: applying the disclosed adhesive composition to one or the other of the upper surface of a roof deck or the lower surface of a roof membrane while leaving the other surface untreated. The roof membrane is then installed onto the roof deck while the adhesive composition is still wet, so that the lower surface of the roof membrane contacts the upper surface of the roof deck. The roof membrane is then rolled with a suitably-weighted roller to assure good contact. Unlike prior art water based adhesives, this method is suitable for unmodified TPO membrane.

Embodiments of the disclosed invention include a method wherein, after the roof membrane is installed onto the roof deck, the adhesive composition is allowed to dry for a period of time sufficient to achieve an adhesive peel strength greater than 5 pounds per inch as determined by test method ASTM D903-98(2017).

Embodiments of the disclosed invention are suitable to be applied to a surface using a spray cannister. The use of a spray canister improves the efficiency of the application because the adhesive can be applied to the surface more quicky and more evenly than manual application methods. Many adhesives are unsuitable for spray cannister application due to their viscosity.

1. A water-based adhesive composition comprising:
a first emulsion polymer, wherein the emulsion polymer comprises from 10 to 80 percent by weight of the adhesive composition;
a second emulsion polymer, wherein the second emulsion polymer comprises from 10 to 55 percent by weight of the adhesive composition;
a rosin ester dispersion, wherein the rosin ester dispersion comprises from 10 to 30 percent by weight of the adhesive composition;
a chlorinated maleic anhydride modified polyolefin dispersion, wherein the chlorinated maleic anhydride modified polyolefin dispersion comprises from 1 to 10 percent by weight of the adhesive composition; and
an isobutyrate-based coalescent, wherein the isobutyrate-based coalescent comprises from 0.20 to 5 percent by weight of the adhesive composition.

2. The water-based adhesive composition of claim 1, wherein the first emulsion polymer is an acrylic copolymer.

3. The water-based adhesive composition of claim 1, wherein the second emulsion polymer is an anionic polychloroprene copolymer rubber.

4. The water-based adhesive composition of claim 1, wherein the second emulsion polymer is a poly(vinyl alcohol) stabilized vinyl acetate-ethylene (VAE) copolymer dispersion.

5. The water-based adhesive composition of claim 1, wherein the composition is adapted to have a TPO to plywood peel strength in the range of 5 piw to 30 piw when measured at 72 F at least 5 months after the adhesive composition adheres a TPO material to a plywood material.

6. The water-based adhesive composition of claim 1, wherein the composition is adapted to have a TPO to aluminum peel strength in the range of 10 piw to 20 piw when measured at 72 F at least 5 months after the adhesive composition adheres a TPO material to an aluminum material.

7. The water-based adhesive composition of claim 1, wherein the composition is adapted to have a TPO to plywood peel strength in the range of 5 piw to 9 piw when measured at 140 F at least 5 months after the adhesive composition adheres a TPO material to a plywood material.

8. The water-based adhesive composition of claim 1, further comprising hydroxyethylcellulose, wherein the hydroxyethylcellulose comprises from 0.1 to 2 percent by weight of the adhesive composition.

9. The water-based adhesive composition of claim 1, further comprising an aqueous ammonia solution comprised of 28 percent by weight of ammonia, wherein the aqueous ammonia solution comprises from 0.01 to 0.5 percent by weight of the adhesive composition.

10. The water-based adhesive composition of claim 1, further comprising an epoxy-functionalized silane or epoxy-functionalized silane oligomer, wherein the epoxy-functionalized silane oligomer comprises from 0.1 to 2.5 percent by weight of the adhesive composition.

11. The water-based adhesive composition of claim 1, wherein the adhesive composition is substantially free of volatile organic compounds.

12. The water-based adhesive composition of claim 1, wherein the adhesive composition is unfilled.

13. The water-based adhesive composition of claim 1, wherein the rosin ester dispersion has a viscosity ranging from 150-1000 cps and wherein the rosin ester dispersion is substantially free of alkyl phenols.

14. The water-based adhesive composition of claim 1, wherein the isobutyrate-based coalescent is trimethyl-1,3-pentane isobutyrate.

15. The water-based adhesive composition of claim 10, wherein the epoxy-functionalized silane oligomer is of high molecular weight with viscosity at 20 C of 700-1200 centistokes.

16. A method for installing membrane roofing, comprising:
a. applying the adhesive composition of claim 1 to a surface selected from the group consisting of an upper surface of a roof deck or a lower surface of a roof membrane while leaving the other surface untreated;
b. installing the roof membrane onto the roof deck while the adhesive composition is still wet, so that the lower surface of the roof membrane contacts the upper surface of the roof deck.

17. The method of claim 16, wherein the roof membrane is an unmodified thermoplastic olefin (TPO) membrane.

18. The method of claim 16, wherein step a is performed using a high pressure canister to apply the adhesive composition.

19. The method of claim 16, further comprising:
c. allowing the adhesive composition to dry for a period of time sufficient to achieve an adhesive peel strength greater than 5 piw as determined by a suitable standardized test method.

20. A method for installing a building material onto a structural member of a building, comprising:
a. applying the adhesive composition of claim 1 to a surface selected from the group consisting of an exterior surface of a structural member or an interior surface of the building material, while leaving the other surface untreated;
b. installing the building material onto the structural member while the adhesive composition is still wet so that the interior surface of the building material contacts the exterior surface of the structural member.

21. The method of claim 20, wherein the building material is selected from the group consisting of: a polyolefin house wrap, polyvinyl chloride trim boards, composite trim boards, composite decking materials and flashing membranes.

22. The method of claim 20 wherein the building material is a thermoplastic polyolefin roofing membrane and the structural member is the roof of a structure.

23. The method of claim 20, where step c is performed using test method ASTM D903-98(2017).

24. The method of claim 20, wherein the adhesive composition is unfilled.
